(19) United States
(12) Patent Application Publication
(10) Pub. No.: US 2026/0363397 A1
(43) Pub. Date: Nov. 19, 2026

(54) IMPROVED ANCHORING DEVICE FOR FOAM-COVERING

(71) Applicant: APLIX, LE CELLIER (FR)

(72) Inventor: Laurent TORLAY, LE CELLIER (FR)

(21) Appl. No.: 19/145,972

(22) PCT Filed: Jan. 8, 2024
(86) PCT No.: PCT/FR2024/050018

§ 371 Date: Jul. 7, 2025

(30) Foreign Application Priority Data
Jan. 9, 2023 (FR) FR2300198

(51) Int. Cl. A44B 18/00; B60N 2/58; D03D 13/00; D03D 15/283

(52) U.S. Cl. CPC A44B 18/0023; D03D 13/004; D03D 15/283; B60N 2/5833; D10B 2505/08

(57) ABSTRACT

A device comprising: a base extending in a machine direction (MD) and a cross direction (CD), having an upper face and a lower face opposite the upper face, an anchoring strip, comprising a backing comprising interlaced warp yarns and weft yarns, a plurality of loops extending from the backing, each loop comprising two legs extending from the backing, and a head forming the opposite end of the loop from the legs, an adhesive securing the anchoring strip to the lower face of the base via the heads of the loops, so as to define a non-zero spacing between the base and the backing of the anchoring strip, the adhesive and the base being formed of different materials.

### CROSS REFERENCE TO RELATED APPLICATIONS

This application is the U.S. National Stage, under 35 U.S.C. § 371, of International Application No. PCT/FR2024/050018, filed Jan. 8, 2024, which claims the benefit of FR Application No. 2300198 filed on Jan. 9, 2023, all of which are incorporated by reference as if fully set forth herein.

### TECHNICAL FIELD

The present disclosure relates to the field of anchoring systems, in particular for fixing trim to a foam.

### PRIOR ART

Self-gripping retaining systems are commonly used to make anchoring systems for fixing foam trim, for example for vehicle seats or upholstery.

Commonly used systems comprise a base having an upper face from which retaining elements project, and an opposite lower face. The retaining elements are typically elements such as hooks or, more generally, elements suitable for making a self-gripping connection with a counterpart, such as loops. The lower face is provided with an assembly of loops. The device is integrated into a product during a foam-covering operation, which partially surrounds the base. The loops ensure that the device is firmly anchored in the foam, which is injected in liquid form and thus interpenetrates the loops.

However, it is understood that the retaining elements must be protected during the foam-covering operation. More specifically, depositing foam on the retaining elements would render them inoperative. A common solution is to apply a protective coating to the upper face of the base; this protective coating then being removed after the foam-covering operation. However, such a method is complex to implement; in particular, the coating removal operation is problematic in terms of industrialisation.

Alternative methods have been envisaged to do away with this protective coating. However, this raises a problem linked to packaging in rolls of products ready to be cut or alternatively directly in a box after cutting the products; the retaining elements then engaging the loops, which is restrictive when handling the product.

FIG. 1 shows an example of such a known device.

The figure shows a device 100 comprising a base 110 extending in a main direction MD and a cross-machine direction CD. The base has an upper face 112 and a lower face 114. Retaining elements 120 extend from the upper face 112 of the base 110, the retaining elements as shown being commonly referred to as having a mushroom shape, and are suitable for making a self-gripping connection with a counterpart such as loops or complementary retaining elements which may be identical or different.

An anchoring strip 130 is secured to the lower face of the base 110. The anchoring strip 130 has a backing 131 for which an upper face 132 and a lower face 134 are defined. Loops 135 extend from the lower face 134 so as to form anchoring means in the foam as previously described.

The anchoring strip 130 is typically secured to the base 110 by means of an adhesive 140, shown here between the lower face 114 of the base 110 and the upper face 132 of the backing 131 of the anchoring strip 130.

As indicated previously, the retaining elements 120 are typically enveloped in a protective coating 150 applied to the upper face 112 of the base 110 so as to envelop all or part of the retaining elements 120. This protective coating 150 must then be removed following a foam-covering operation designed to anchor the device 100 in a foam element, the anchoring being achieved, in particular, by integrating the loops 135 into the foam.

As indicated above, removing this protective coating 150 is problematic and restrictive. Doing away with this protective coating poses problems relating to the protection of the retaining elements 120 during the foam-covering operation, and also relating to packaging, because the retaining elements 120 then engage the loops 135 when the product is packaged in rolls ready to be cut or is packaged loosely in a box after cutting.

Other anchoring systems are commonly used to fix a plurality of layers together, for example to provide insulation, in particular thermal and/or acoustic and/or mechanical and/or light and/or air and/or moisture insulation. The systems commonly used are of various structures and made of very different materials, depending on the intended application and/or the performance to be achieved.

Commonly used systems generally comprise either a stack of many layers of different materials and having different structures in order to achieve the desired performance for the application, without this structure being able to be used for different functions and/or applications, or a single layer with various structures. It is understood that such systems are restrictive due to their specific features. There is therefore a need to produce systems with a simpler structure that can be used for a wide variety of applications.

Thus, the present disclosure aims to at least partially respond to these problems.

### Disclosure

In order to at least partially respond to the above-mentioned problems, the present disclosure relates to
a device, in particular intended to be at least partially enveloped in an envelope, comprising:
a base extending in a machine direction and a cross direction, having an upper face and a lower face opposite the upper face, the upper face being provided with retaining elements,
an anchoring strip, in particular intended to be at least partially enveloped in an envelope, comprising
a backing comprising interlaced warp yarns and weft yarns, the backing forming a plurality of interlacings of continuous warp yarns in the machine direction and spaced apart in the cross direction,
a plurality of loops extending from the backing, each loop comprising two legs extending from the backing, and a head forming the opposite end of the loop from the legs,
   characterised in that
   the device comprises, a securing means securing the anchoring strip to the lower face of the base via at least some of the heads of the loops, in particular so as to define a non-zero spacing between the base and the backing of the anchoring strip, said non-zero spacing being intended, in particular, to receive an envelope for fixing the device,
   and in that the securing means and the base are formed of different materials.

Thus, the device has a backing with less residual deformation than the prior art and with better resistance to deformation, in particular better resistance to compression, and better distribution of the force applied to the backing of the anchoring strip and/or potentially better resistance to traction and/or shear after it has been anchored in a material.

According to one example, the backing of the anchoring strip and the base are spaced apart by a distance of between 0.2 mm and 10 mm, or between 0.5 mm and 7 mm, in some cases between 0.5 mm and 5 mm, in particular between 2.5 mm and 5 mm.

According to one example, the anchoring strip has a grammage per unit area of between 25 and 350 g/m², in particular between 30 and 220 g/m², or between 50 and 220 g/m².

According to one example, the anchoring strip has an apparent density, calculated from the ratio of the grammage per unit area (in g/m²) and the height of the anchoring strip (in mm), of between 1 and 500 kg/m³, in particular between 2 and 200 kg/m³, 3 and 100 kg/m³.

According to one example, the two loop portions arranged between the loop head and respectively the loop legs extend in a direction not perpendicular to the plane formed by the base and/or a direction not perpendicular to the plane comprising the machine direction and the cross direction.

According to one example, the two loop portions arranged between the loop head and respectively the loop legs have a different shape, for example, one is straight or substantially straight and the other is curved or substantially curved.

According to one example, the backing has a thickness of between 30 micrometres and 1200 micrometres, in particular between 50 micrometres and 800 micrometres.

According to one example, the loops comprise a crossing of the legs.

According to one example, the anchoring strip, in particular the backing, comprises, viewed perpendicular to the plane comprising the machine and cross direction, a number of openings with between 5 and 100 openings per cm², in particular with each opening having a surface area of at least 1.0 mm² , or a number of openings between 5 and 60 openings per cm², with each opening having a surface area of at least 1.5 mm² , or a number of openings with between 5 and 50 openings per cm², with each opening having a surface area of at least 1.8 mm² . According to one example, the openings have the general shape of a square, rectangle, trapezium, circle or the like. In a particular case, the shape of the opening has an asymmetry in the machine and/or cross direction to facilitate insertion of the envelope into the anchoring strip, which envelope is formed for example from a foam and/or plaster and/or concrete and/or a crosslinked plastic material and/or a thermosetting material.

According to one example, the anchoring strip, in particular the backing, has, when viewed perpendicular to the plane comprising the machine and cross direction, an opening ratio (surface of the open backing/surface considered) of between 50% and 90% per cm², in particular between 60% and 90% per cm², more particularly between 70% and 90% per cm².

According to one example, the heads of the loops are secured to the lower face of the base so that they do not project from the upper face of the base.

According to one example, at least 50% of the loops of the anchoring strip are secured to the lower face of the base, or typically at least 75% of the loops of the anchoring strip are secured to the lower face of the base, or in some cases 100% of the loops of the anchoring strip are secured to the lower face of the base.

According to one example, the upper face of the base is provided with retaining elements.

According to one example, the anchoring strip comprises a plurality of leg loops which are arranged in the plane of the backing and/or project from the lower face of the backing (or of the anchoring strip).

According to one example, the leg loops have a shape for which the dimensions are all less than the dimensions of the loops projecting from the upper face.

According to one example, the leg loops and the loops projecting from the upper face are made from the same yarn, so there is typically a continuity of material between the leg loops and the loops projecting from the upper face.

According to one example, the base is formed of a woven and/or knitted material, each retaining element comprising a stem and a head,
the stem extending from the upper face of the base, and the head being formed at a free end of the stem opposite the upper face of the base,
the stems of the retaining elements extending at least partly into the woven and/or knitted material of the base.

The base is typically formed of monofilament and/or multifilament synthetic yarns, typically interlaced, in particular by weaving and/or knitting, for example a multifilament yarn with a number of filaments between 2 and 25 filaments, in particular between 2 and 15 filaments.

Said synthetic yarns are made, for example, from at least one or more thermoplastic materials.

The yarns typically have a diameter between 30 and 600 micrometres, or between 70 and 550 micrometres.

According to one example, the backing of the anchoring strip extends continuously in the machine direction.

The securing means is typically an adhesive or a glue.

According to one example, the device comprises a plurality of anchoring strips superimposed so as to define a plurality of layers of anchoring strips in a direction perpendicular to the lower face of the base.

According to one example, the anchoring strips of the various successive superimposed layers extend in perpendicular directions. The device can thus have, for example, a superposition of layers in which the anchoring strips extend continuously in the machine direction and in the cross direction.

According to one example, the anchoring strips of the superimposed layers are secured to each other by means of an adhesive.

According to one example, the upper face of the base is provided with retaining elements, for example retaining elements for forming a self-gripping fixation, in particular formed by weaving, knitting, injection moulding or extrusion moulding.

According to one example, the base is formed of a woven and/or knitted material, each retaining element comprising a stem and a head,
the stem extending from the upper face of the base, and the head being formed at a free end of the stem opposite the upper face of the base,
the stems of the retaining elements extending at least partly into the woven and/or knitted material of the base.

According to one example, the upper face of the base is provided with a layer comprising a vapour barrier film and/or an airtight film and/or a kraft paper and/or a wall covering and/or a plasterboard sheet and/or a cardboard sheet and/or a decorative or other covering.

The application also relates to an assembly which comprises an envelope and a device as previously defined, wherein the envelope at least partially surrounds the anchoring strip, in particular at least partially surrounds the loops of the anchoring strip and/or the backing of the anchoring strip.

For example, the envelope is formed from a foam, plaster or concrete material and/or a cross-linked plastic and/or a thermosetting material.

### BRIEF DESCRIPTION OF THE DRAWINGS

The application and its advantages will be better understood on reading the following detailed description of various embodiments on the application presented by way of non-limiting examples.

FIG. 1 shows an example of a known device.

FIG. 2 shows an example of a device.

FIG. 3 shows another view of the device shown in FIG. 2.

FIG. 4 shows an exemplary application.

FIG. 5 shows another exemplary application.

FIG. 6 shows another exemplary application.

FIG. 7 shows another exemplary application.

FIG. 8 shows another exemplary application.

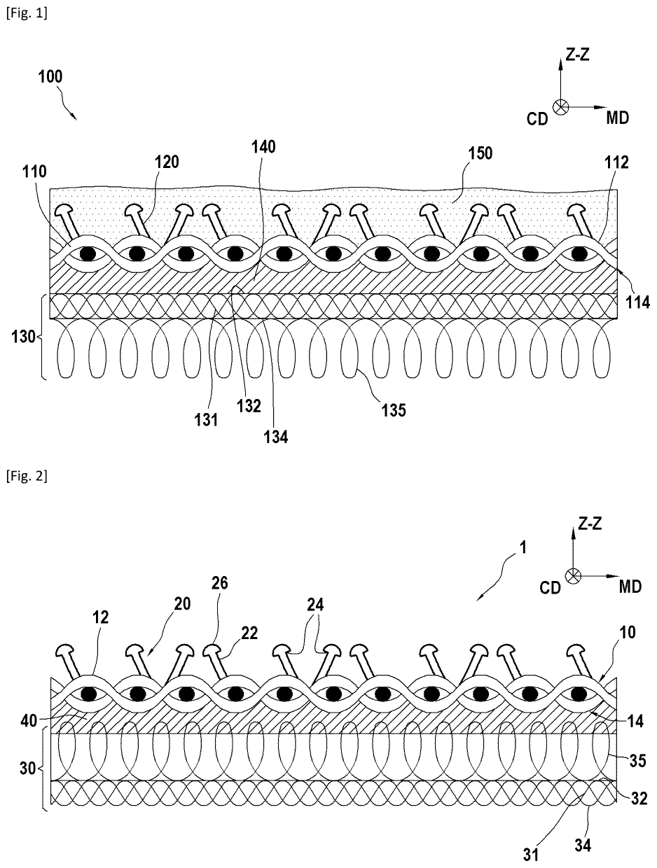

In all of the figures, the elements in common are labelled by identical numerical reference signs.

### DESCRIPTION OF THE EMBODIMENTS

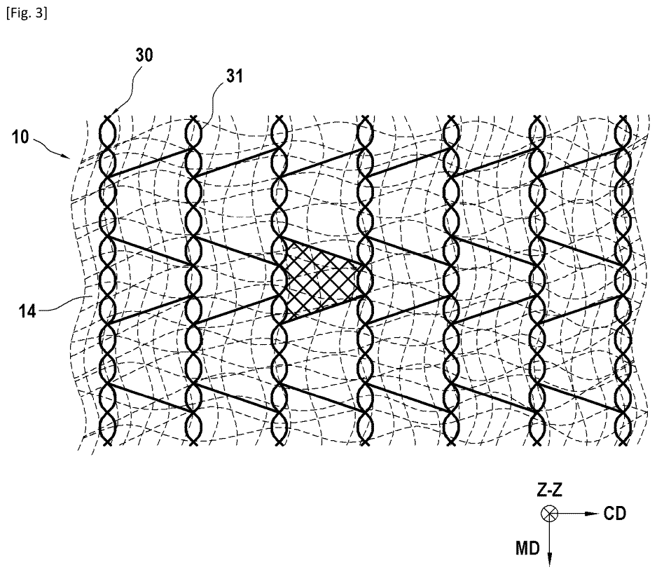

FIGS. 2 and 3 show an example of a device.

These figures show a device 1 comprising a base 10 and an anchoring strip 30.

The base 10 has a strip shape extending in a machine direction MD and a cross direction CD. The longitudinal direction is commonly referred to as being the machine direction. An upper face 12 and a lower face 14 are arbitrarily defined for the base 10.

For the purposes of illustration, it will be assumed that the upper face 12 and the lower face 14 are flat or substantially flat. A vertical direction Z-Z is defined, perpendicular to the machine direction MD and to the cross direction CD, and therefore perpendicular to the upper face 12 and to the lower face 14 of the base 10.

The base 10 is typically produced by injection moulding and/or extrusion, and is for example formed in one piece with the retaining elements. In an embodiment corresponding to the example illustrated, the base 10 is a woven fabric comprising a bottom yarn and a warp yarn interlaced with each other. In an alternative embodiment, the base 10 is a knitted fabric comprising a bottom yarn and a warp yarn interlaced with each other. In such embodiments, the base 10 does not therefore have a flat lower face 14, the yarns making it up forming undulations or waves. The base 10 can also be formed by a continuous or non-continuous strip of material.

The base 10 is typically formed from woven monofilament and/or multifilament synthetic yarns. By way of example, the loop yarns and/or weft yarns and/or warp yarns are monofilament or multifilament yarns, for example a multifilament with a number of filaments of between 2 and 25 filaments, in particular between 2 and 15 filaments. Said synthetic yarns are made, for example, from thermoplastic material. The yarns typically have a diameter between 30 and 600 micrometres, or between 70 and 550 micrometres.

In the illustrated embodiment, a plurality of retaining elements 20 extend from the upper face 12 of the base 10. The retaining elements 20 are suitable for co-operating with a counterpart, which may for example be complementary or identical retaining elements, loops or a non-woven material, to provide a self-gripping connection. As will be seen below, the retaining elements 20 are optional, and the application also has technical effects in the absence of such retaining elements 20.

In the example shown, the retaining elements 20 are formed by yarns arranged at least in part in the base 10. More particularly, the yarns forming the retaining elements 20 are monofilament yarns. The yarns forming the retaining elements 20 are arranged in the base 10 in the form of a “V” and/or “W”.

The retaining elements 20 as shown are generally mushroom-shaped. They each comprise a stem 22 extending from the upper face 12 of the base 10, and a head 26 formed at the free end 24 of the stem 22. The head 26 as shown has the shape of a half-sphere or a portion of a sphere. It is understood that this example is limiting, and that the retaining elements 20 may have any suitable geometry. The retaining elements 20 could be of types other than mushrooms, for example hooks produced by injection and/or extrusion and/or harpoons or could even be loops, for example loops formed by weaving, knitting and/or other assembly.

The device 1 also has an anchoring strip 30, secured to the lower face 14 of the base 10.

The anchoring strip 30 has a backing 31 for which an upper face 32 and a lower face 34 are defined, the designation being arbitrary and chosen here to be consistent with the designation of the faces of the base 10.

Loops 35 extend from one face of the base 31, these loops being suitable for forming anchoring means in a foam material injected against the lower face 14 of the base 10.

As will be seen below, the loops 35 here extend from the upper face 32 of the backing 31.

The backing 31 typically has a thickness of between 30 and 1000 μm, or between 50 and 700 μm.

The loops 35 can extend in a direction perpendicular to the plane formed by the lower face 14 of the base 10, or in a direction not perpendicular to the plane formed by the lower face 14 of the base 10.

The base 31 is typically formed by a knitted fabric, for example with one or more yarns.

The anchoring strip 30 may have leg loops extending from the lower face 34 of the base 31 and/or in the plane of the backing 31. The leg loops typically have maximum dimensions that are strictly smaller than the loops 35 projecting from the upper face 32 of the backing 31.

The loops 35, the backing 31 and, where applicable, the leg loops are typically formed by the same yarns; there can therefore typically be a continuity of material between the backing 31, the loops 35 and, where applicable, the leg loops.

The loops 35 are typically loop yarns extending at least partially into the backing 31 of the anchor strip 30. The loops 35 are typically knitted so as to extend at least partially into the backing 31 of the anchoring strip 30.

The loops 35 are typically formed by loop yarns extending from the upper face 32 of the backing 31.

The loops 35 are typically arranged in rows and/or columns extending respectively in the cross direction CD and the machine direction MD. The loops 35 in the same row or column are typically formed by the same continuous loop yarn.

The anchoring strip 30 is typically formed of yarns having a diameter between 30 and 600 μm, or between 70 and 550 μm. The use of yarns with such a diameter prevents the yarns from cutting the material which will then envelop the anchoring strip 30.

According to one example, the knitted fabric has stitches, the loops of which are linked together, for example by intersecting the legs of adjacent loops, or are in contact with each other. Such a structure makes it possible to improve the hold of the loops, which is particularly advantageous for applications in which a damping effect is sought. In addition, this structure gives the mesh volume and a shape memory effect.

FIG. 3 schematically shows an example of the arrangement of an anchoring strip 30 on the lower face 14 of the base 10. The loops 35 have not been shown in this figure to improve legibility. The anchoring strip 30 typically comprises a plurality of warp yarns, each typically extending in the machine direction MD and forming a continuous interlacing in the machine direction MD, and a plurality of weft yarns typically extending in the cross direction CD, the warp and weft yarns being interwoven. The warp and weft yarns form anchoring elements which can be positioned in a regular or irregular manner along the main direction MD and/or the cross direction CD on the lower face 14 of the base 10. The weft yarns provide a link between the various warp yarns, and define a discontinuous pattern in the cross direction CD. The weft yarns typically extend in the cross direction CD, but may also have a non-zero component in the machine direction MD, as shown in FIG. 3. In FIG. 3, the backing 31 is represented by bold lines and the base 10 is represented by broken lines. In the illustrated example, the warp yarns thus define a plurality of interlacings each extending in the machine direction MD, and spaced apart in the cross direction CD. Weft yarns extend between the various interlacings of warp yarns. The interlacings of warp yarns are thus only connected by the weft yarns. The warp yarns forming one warp-yarn interlacing are separate from the warp yarns forming another warp-yarn interlacing. Considering that the width W of a warp-yarn interlacing is equal to the maximum dimension of this interlacing in the cross direction CD, the various warp-yarn interlacings are typically spaced apart by a distance in the cross direction greater than or equal to 2 W, or typically greater than or equal to 3 W.

The base 31 as shown thus comprises several warp-yarn interlacings, spaced-apart from one another and joined together by weft yarns that are likewise spaced-apart from one another, thus forming an open structure, as opposed to a solid strip.

As schematically shown in FIG. 2, the anchoring strip 30 is secured to the lower face 14 of the base 10. However, unlike known devices, the anchoring strip 30 is secured to the lower face 14 of the base 10 by the loops 35. More specifically, a leg and a head are defined for the loops, the leg being connected to the upper face 32 of the base 31, and the head forming the end of the loop 35 furthest from the backing 31. The legs of the loops 35 are typically crossed.

According to one example, for one loop 35, typically for each loop 35, the two loop portions arranged between the loop head and respectively the loop legs extend in a direction not perpendicular to the plane formed by the base and/or a direction not perpendicular to the plane comprising the machine direction MD and the cross CD direction.

The two loop portions arranged between the loop head and the loop legs may respectively have the same or different shapes. For example, one may be straight or substantially straight and the other curved or substantially curved.

The anchoring strip 30 is secured to the lower face 14 of the base 10 via the heads of the loops 35. In this way, all or some of the heads of all or some of the loops 35 of the anchoring strip 30 are secured to the lower face 14 of the base 10.

In the example illustrated in FIG. 2, a securing means 40, for example a layer of adhesive, is shown to secure the loops 35 to the lower face 14 of the base 10. It is understood that this embodiment is not limiting, and that any suitable securing means may be used, for example an adhesive or a glue. The securing means 40 and the base 10 are formed of different materials.

The securing means 40 extends over a height which is typically less than the maximum height separating the anchoring strip 30 from the lower face 34 of the backing 31 of the anchoring strip 30, or typically less than the height of the loops 35. In this way, the securing means 40 is at a distance from the backing 31 of the anchoring strip 30. In other words, there is a non-zero distance between the securing means 40 and the upper face 32 of the backing 31 of the anchoring strip 30. The loops 35 are therefore not entirely enclosed by the securing means 40; the loops 35 thus have a non-zero height not enveloped by the securing means.

This configuration thus ensures a non-zero spacing between the base 10 and the backing 31 of the anchoring strip 30. The loops 35 act as a spring or damper between the base 10 and the backing 31.

According to one example, the backing 31 of the anchoring strip 30 and the base 10 are spaced apart by a distance of between 0.2 mm and 10 mm, or between 0.5 mm and 5 mm. This spacing typically corresponds here to the distance between the lower face 14 of the base 10 and the upper face 32 of the backing 31 of the anchoring strip 30.

According to one example, the heads of the loops are secured to the lower face 14 of the base 10 so that they do not project from the upper face 12 of the base 10. The loops 35 do not typically pass through the entire base 10. The loops 35 may partially penetrate the thickness of the base 10, particularly in the case where the base 10 is formed by a tangle of fibres or yarns.

According to one example, at least 50% of the loops 35 of the anchoring strip 30 are secured to the lower face 14 of the base 30, or typically at least 75% of the loops 35 of the anchoring strip 30 are secured to the lower face 14 of the base 30, or at least 80% of the loops 35 of the anchoring strip 30 are secured to the lower face 14 of the base 30, or at least 90% of the loops 35 of the anchoring strip 30 are secured to the lower face 14 of the base 30 and in one case 100% of the loops 35 of the anchoring strip 30 are secured to the lower face 14 of the base 30.

According to one example, at least 1% of the height of the loops 35 is secured to the base 10, or at least 2%, and at most 25%, in particular at most 20% of the height of the loops 35 is secured to the base 10. By secured to the base 10, we mean here that part of a loop 35 which is fixed to the base 10 by an adhesive or glue, and is enveloped by the adhesive or glue, for example.

The device as proposed has several advantages. In the case where the device is provided with retaining elements 20, it makes it possible in particular to avoid the problems mentioned in the introduction and linked to the packaging of products in the form of rolls or products directly in a box, after it has been cut. When the product is packaged in rolls, the retaining elements 20 come into contact with the backing 31 and not the loops 35, thus avoiding a self-gripping connection during packaging in rolls.

In addition, the anchoring properties in a foam material injected against the lower face 14 of the base 10 are retained; anchoring is provided by the loops 35 and by the backing 31. More generally, the device may be associated with a material forming an envelope at least partially surrounding the anchoring strip 30, typically at least partially surrounding or enveloping the loops 35 of the anchoring strip 30 and/or the backing 31 of the anchoring strip 30. The envelope is typically formed of foam, plaster and/or concrete. The envelope typically forms a support or part of a support, a support here referring to an object or material element on which something rests, in particular a heavy object, intended to serve as a support or backing for the latter. The support is used here to support the device or assembly in a configuration or position of use, depending on the application. More generally, the device as proposed is thus an anchoring device, which may also be a retaining device in the case where it has retaining elements 20.

The device as proposed may also have advantages in different types of application.

For example, the device 1 may be used for fixing a covering to a surface, for example a floor or wall covering, or for a seat, typically foam, concrete, plaster or any other element intended to be fixed to a support and which may, for example, be in the form of a plate. The device is typically overmoulded in the material, which forms an envelope surrounding all or part of the anchoring strip 30, typically surrounding all or part of the loops 35 of the anchoring strip 30 and/or all or part of the backing 31 of the anchoring strip 30. As indicated previously, this total or partial enveloping of the loops 35 and/or of the backing 31 of the anchoring strip 30 ensures that the device is anchored in the material, or vice versa.

The anchoring strip 30 typically has a structure that can be described as open.

Openings are defined as the open areas between two sets or interlaces of adjacent warp yarns, and between two adjacent weft yarns, as viewed in a plane perpendicular to the machine direction MD and to the cross direction CD, from the lower face 34 of the backing 31 of the anchoring strip 30. An opening is typically defined as an area having a surface area of at least 1 mm² in this plane, or at least 1.5 mm², or at least 1.8 mm².

According to one example, the anchoring strip 30 has, as seen in a plane perpendicular to the machine direction MD and to the cross direction CD, from the lower face 34 of the backing 31 of the anchoring strip 30, a number of openings of between 5 and 100 openings per cm², each opening having a surface area of at least 1.0 mm², or a number of openings of between 5 and 60 openings per cm², each opening having a surface area of at least 1.5 mm², or a number of openings of between 5 and 50 openings per cm², each opening having a surface area of at least 1.8 mm². An example of an opening in the anchoring strip 30 has been represented by a grid in FIG. 3.

According to one example, the anchoring strip 30 has, as seen in a plane perpendicular to the machine direction MD and to the cross direction CD, from the lower face 34 of the backing 31 of the anchoring strip 30, an opening ratio of between 50% and 90% per cm², in particular between 60% and 90% per cm², more particularly between 70% and 90% per cm², the opening ratio being defined as the ratio between the surface area of the openings in the backing 31 relative to the surface area under consideration.

Such an open structure of the anchoring strip 30, and more precisely of the backing 31 of the anchoring strip 30, ensures good penetration of the material, for example the injected material, and therefore good anchoring of the device in a material such as foam or more generally any other material penetrating the anchoring strip 30.

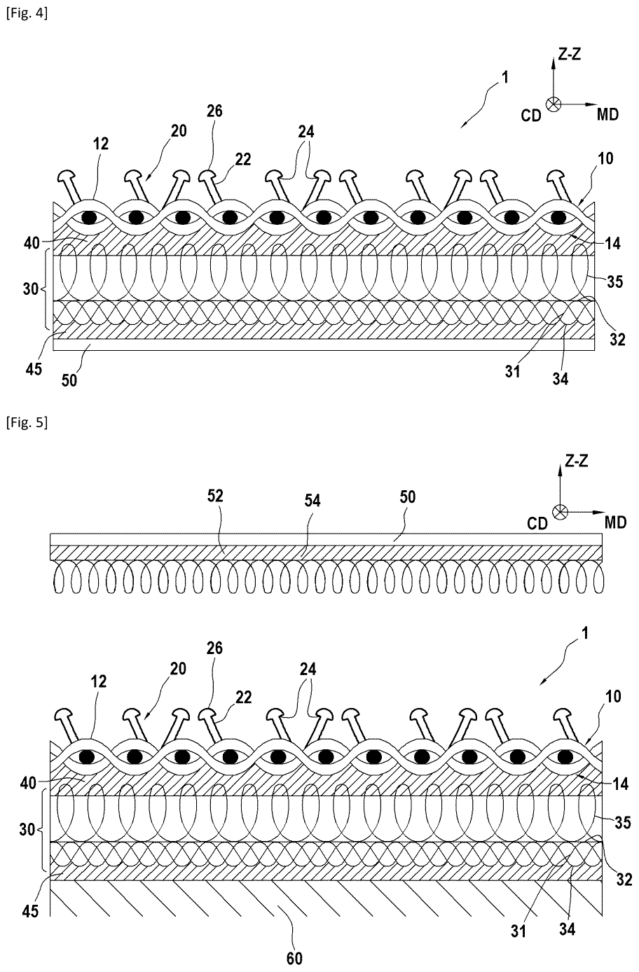

FIG. 4 illustrates such an application.

The figure shows that a coating is secured to the lower face 34 of the base 31, in this case by means of a layer of adhesive 45. The product thus formed can be assembled on a counterpart fixed to a support such as a wall, floor, ceiling or surface of an object.

The proposed structure, which provides a non-zero spacing between the base 10 and the backing 31, ensures the formation of an air gap between the base 10 and the backing 31, and consequently between the base 10 and the coating 50, thus providing a damping or insulating function.

Optionally, this damping or insulating effect can be accentuated by superimposing several anchoring strips 30.

FIG. 5 shows a variant of FIG. 4, in which the device 1 is secured to a support 60. The covering 50 is secured to a counterpart 54, in this case a counterpart with loops, by means of a layer of adhesive 52. This counterpart 54 is suitable for forming a self-gripping connection with the device 1, by engaging the retaining elements 20.

This variant offers the same advantages as in the embodiment illustrated with reference to FIG. 4.

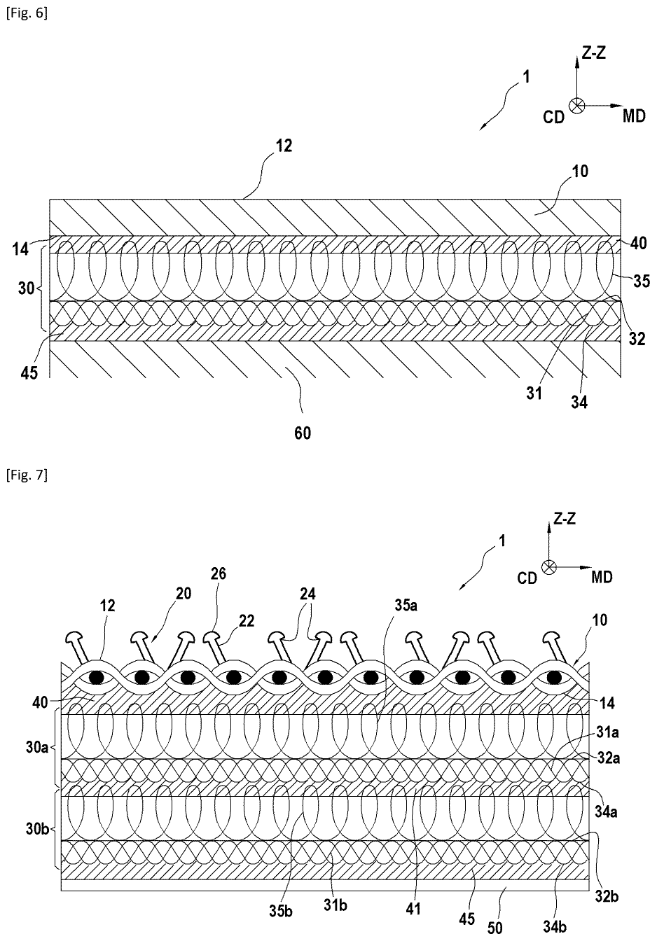

As an alternative to the embodiment shown in FIG. 5, the base 10 can form the covering. FIG. 6 schematically illustrates such an alternative.

In this type of embodiment, the base 10 typically has no retaining elements 20. This alternative thus exploits the properties of the anchoring strip 30 to form an air gap between the support 60 and the base 10 forming the coating, and thus provides a thermal insulation and damping function. The base 10 can then comprise a vapour barrier film secured to its lower face 14, or integrated into the base 10.

In such an embodiment, the proposed device forms a versatile anchoring device, making it possible to perform an insulating function, in particular thermal and/or acoustic and/or mechanical and/or light and/or air and/or moisture insulation, with a simplified and versatile structure for numerous applications.

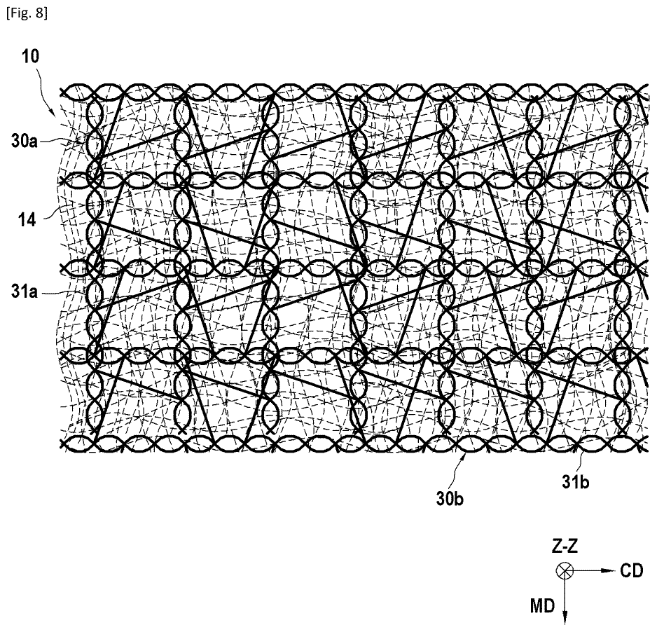

FIGS. 7 and 8 schematically illustrate alternatives of the embodiment shown in FIG. 4. It is understood that similar alternatives can be produced with reference to the embodiment shown in FIG. 5 or FIG. 6. As in FIG. 3, to FIG. 8, the backings 31 are shown as bold lines and the base 10 is shown as broken lines, and the loops 35 are not shown in this figure in order to improve legibility.

FIG. 7 illustrates the superposition of two anchoring strips 30 in the same direction, in this case the machine direction MD. The two anchoring strips are identified by numerical reference signs 30a and 30b, their individual elements being identified by the same numerical reference signs already used in FIGS. 2 and 4, to which the subscript a or b has been added. An additional adhesive layer 41 secures the anchoring strip 30b to the lower face 34a of the base 31a of the anchoring strip 30a. More specifically, the loops 35b of the anchoring strip 30b are secured to the lower face 34a of the base 31a of the anchoring strip 30a by means of the adhesive 41. This configuration makes it possible to maintain the effects mentioned above with particular reference to FIG. 2, and in particular to prevent engagement of the retaining elements 20 with the loops of the anchoring strips 30a and 30b.

The thickness of the air gap between the base 10 and the backing 31, and consequently between the base 10 and the covering 50, is therefore increased compared to the embodiment shown in FIG. 4, 5 or 6, which increases the insulating and damping effect.

It is understood that this embodiment can be generalised for any number of superimposed layers of anchoring strips using a device according to the invention application. The various layers of anchoring strips thus formed may, for example, be formed of anchoring strips 30 aligned and thus extending in the same direction, so that the anchoring strips of two superimposed layers are thus typically superimposed and aligned with respect to one another. Alternatively, the anchoring strips of the different layers superimposed in this way can be arranged so that they intersect. For example, a configuration may be proposed with a first layer formed of anchoring strips extending in the machine direction MD, and a second layer formed of anchoring strips extending in the cross direction CD.

FIG. 8 schematically shows another example of the superposition of two anchoring strips 30a and 30b. In this example, the anchoring strips 30a forming a first thickness are aligned in the machine direction MD, while the anchoring strips 30b forming a second thickness are aligned in the cross direction CD.

In such an application, a vapour barrier film can typically be interposed between the anchoring strips 30 and the covering 50, or, where applicable, between two superimposed anchoring strips 30. The vapour barrier film is typically held in place by two securing means on either side, for example two layers of adhesive or glue on either side of the vapour barrier film.

Although the present invention has been described by referring to specific exemplary embodiments, it is obvious that modifications and changes can be made to these examples without going beyond the general scope of the invention as defined by the claims. In particular, the individual features of different embodiments illustrated or mentioned can be combined in additional embodiments. Consequently, the description and the drawings should be considered as illustrating rather than limiting.

It is also obvious that all the features described in reference to a method can be transposed, alone or in combination, to a device, and inversely, all the features described in reference to a device can be transposed, alone or in combination, to a method.

1. A device, in particular intended to be at least partially enveloped in an envelope, comprising:
a base extending in a machine direction (MD) and a cross direction (CD), having an upper face and a lower face opposite the upper face,
an anchoring strip, in particular intended to be at least partially enveloped in an envelope, comprising
a backing comprising interlaced warp yarns and weft yarns, the backing forming a plurality of interlacings of continuous warp yarns in the machine direction (MD) and spaced apart in the cross direction (CD),
a plurality of loops extending from the backing, each loop comprising two legs extending from the backing, and a head forming the opposite end of the loop from the legs,
wherein the device comprises, a securing element securing the anchoring strip to the lower face of the base via at least some of the heads of the loops, in particular so as to define a non-zero spacing between the base and the backing of the anchoring strip, which non-zero spacing is intended, in particular, to receive an envelope for fixing the device,
and wherein the securing element and the base are formed of different materials.

2. The device according to claim 1, wherein the backing of the anchoring strip and the base are spaced apart by a distance of between 0.2 mm and 10 mm, or between 0.5 mm and 5 mm.

3. The device according to claims 1, wherein the heads of the loops are secured to the lower face of the base so as not to project from the upper face of the base.

4. The device according to claims 1, wherein at least 50% of the loops of the anchoring strip are secured to the lower face of the base, or typically at least 75% of the loops of the anchoring strip are secured to the lower face of the base.

5. The device according to claims 1, wherein the base is formed of monofilament and/or multifilament synthetic yarns that are interlaced, in particular by weaving and/or knitting.

6. The device according to claim 5, wherein said synthetic yarns are made of thermoplastic material.

7. The device according to claims 5, wherein the yarns have a diameter between 30 and 600 micrometres, or between 70 and 550 micrometres.

8. The device according to claims 1, wherein the backing of the anchoring strip extends continuously in the machine direction (MD).

9. The device according to one of claims 1, comprising a plurality of anchoring strips superimposed so as to define a plurality of layers of anchoring strips in a direction perpendicular to the lower face of the base.

10. The device according to claim 9, wherein the anchoring strips of the superimposed layers are secured to each other by an adhesive.

11. The device according to claims 1, wherein the upper face of the base is provided with retaining elements

12. The device according to claim 11, wherein the base is formed of a woven and/or knitted material, each retaining element comprising a stem and a head the stem extending from the upper face of the base and the head being formed at a free end of the stem opposite the upper face of the base, the stems of the retaining elements extending at least partly into the woven and/or knitted material of the base.

13. The device according to claims 1, wherein the securing element is an adhesive or a glue.

14. An assembly which comprises an envelope and a device, wherein the envelope at least partially surrounds an anchoring strip, in particular at least partially surrounds loops of the anchoring strip and/or a backing of the anchoring strip.

15. The assembly according to claim 14, wherein the envelope is formed of a material made of foam and/or plaster and/or concrete and/or of a cross-linkable plastic material and/or of a thermosetting material.

16. An assembly comprising:
an envelope at least partially surrounding loops and/or a backing of an anchoring strip, and
a device,
wherein the device comprises a base extending in a machine direction (MD) and a cross direction (CD), the base having an upper face and a lower face opposite the upper face,
wherein the anchoring strip comprises the backing, wherein the backing comprises interlaced warp yarns and weft yarns, the backing forming a plurality of interlacings of continuous warp yarns in the machine direction (MD) and spaced apart in the cross direction (CD).

17. The assembly of claim 16, wherein each loop of the plurality of loops comprises two legs extending from the backing, and a head forming the opposite end of the loop from the legs.

18. The assembly of claim 17, wherein the device further comprises a securing element for securing the anchoring strip to the lower face of the base via at least some of the heads of the loops.
